(19) United States
(12) Patent Application Publication
(10) Pub. No.: US 2024/0134143 A1
(43) Pub. Date: Apr. 25, 2024

(54) ACTUATOR FOR CAMERA

(71) Applicant: JAHWA electronics Co., Ltd., Cheongju-si (KR)

(72) Inventors: Chul Soon PARK, Cheongju-si (KR); Hyeon Ik CHO, Chungcheongbuk-do (KR)

(21) Appl. No.: 18/317,187

(22) Filed: May 14, 2023

(30) Foreign Application Priority Data
Oct. 23, 2022 (KR) 10-2022-0137634

(51) Int. Cl. G02B 7/02; G03B 17/17; H02N 11/00

(52) U.S. Cl. CPC G02B 7/021; G03B 17/17; H02N 11/006

(57) ABSTRACT

The embodiment disclosed herein is an actuator for camera comprising a lens module emitting light towards an image sensor; a housing enclosing the lens module; and a patterned member disposed on the internal surface of the housing wherein the internal surface is the one between the lens module and the image sensor. The patterned member comprises protrusions arranged in repetition along an optical axis, in which each protrusion extends lengthwise along a direction perpendicular to the optical axis.

### TECHNICAL FIELD

The present disclosure relates to actuators for camera and camera modules comprising the same. More particularly, the present disclosure relates to actuators for camera capable of reducing flare e.g., from internal reflection.

### BACKGROUND ART

As the hardware technology for image processing has been developed and the user needs for image shooting have increased, functions such as autofocus (AF) and optical image stabilization (OIS) have been applied to a camera module or the like, mounted to a portable terminal such as a cellular phone and a smart phone as well as an independent camera device.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

In addition, an optical image stabilization (OIS) function means a function of improving the sharpness of an image by adaptively moving the carrier having a lens in a direction to compensate for the shaking when the lens is shaken due to trembling.

Current mobile terminals are equipped with zoom lenses the specifications of which support such features as variable focal adjustments and taking pictures of long distance images to suit heightened consumer needs and to further user convenience.

Since zoom lenses as such either have a structured of multiple lens or lens assemblies in parallel arrays or are distinguished by having an extended dimension along the optical axis, they accordingly demand larger space in the mobile terminals that house them.

As an effort to reconcile zoom lenses with such physical features seamlessly with the shape of mobile terminals, there have been recent developments in actuators and camera modules including those with physical structures in which the light from the object is refracted by means of a reflectometer placed anterior to the lens.

The light from an object passing through the lens can take optical paths the angles of incidence of which may have a broad distribution. An increase in the distance between the lens and the image sensor, for example in back focal length (the distance between the image sensor and the physical end of an optical system), may lead to the phenomenon of flare, an occurrence of light saturation in some part of the image as some of the light that exited the lens can reflect off the internal surfaces such as the housing and enter the image sensor.

The problem of flare becomes worse for actuators equipped with a reflectometer as the distance to the image sensor, starting from the reflectometer, becomes even longer.

Embodiments in which the housing or case (shield can) are installed with reflection suppressor made of light-absorbing or poorly reflective material have been known in the art to address this problem.

These embodiments, however, suffer from not only reduction in process efficiency due to the additional step of installing the reflection suppressor to the actuator, but generation and airborne scattering of foreign matter such as breakaway particles and debris from the suppressor material in particular since the reflection suppressor is formed out of such material as film, paint and non-wovens.

Foreign matter generated as such may limit the driving precision of actuators and may well proceed to causing image deterioration in another level such as dead pixels since the foreign matter can get stuck to the surfaces of the lenses and image sensors or block the optical path.

### DISCLOSURE

### Technical Problem

The present invention has been contemplated to solve the aforementioned problems in the context mentioned above. It is a technical goal of the present invention to provide an actuator for camera capable of effectively reducing flare by means of a physical structure readily implementable on the internal surface of the housing.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Technical Solution

To achieve the technical goals mentioned above, in one aspect of the present invention is provided an actuator for camera comprising a lens module from which light exits towards an image sensor, a housing enclosing the lens module; and a patterned member disposed on the internal surface of the housing, said internal surface being the one between the lens module and the image sensor. The patterned member of the present invention in which case is configured to comprise protrusions arranged in repetition along an optical axis where each protrusion extends lengthwise along a direction perpendicular to the optical axis.

Preferably, the protrusion of the present invention has a triangular cross section. Specifically, the protrusion of the present invention comprises a vertical surface perpendicular to the internal surface of the housing and a sloping surface the face of which points towards the image sensor.

Depending on the particular embodiment, the present invention further comprises a reflectometer module that is disposed anterior to the lens module and reflects the light from the object towards the lens module.

Furthermore, the patterned member of the present invention may have its exposed face subject to a roughening surface treatment. The patterned member is preferably formed integral to the housing.

### Advantageous Effects

According to a preferred embodiment of the present disclosure, effective reduction of flare caused by such processes as internal reflection can be achieved with structural improvements that are not complicated.

Since the present invention can be implemented by processing or molding the internal surface of the housing, an integral part of the actuator, it can be readily applied to general manufacturing process for actuator parts. The efficiency of the manufacturing process itself can be improved since it obviates additional step for implementing special purpose component as in prior art.

Furthermore, precision in actuator driving can be consistently maintained according to the present invention since generation of foreign matter is prevented from the outset by forgoing addition of a component formed out of foreign materials.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 to 3 illustrate the overall configuration of an actuator for camera and a camera module in accordance with a preferred embodiment of the present invention;

FIGS. 4A-4B illustrates the configuration in detail of the reflectometer module according to a preferred embodiment of the present invention;

FIG. 5 illustrates the configuration in detail of an actuator for camera according to the present invention;

FIGS. 6A-6B illustrates a housing equipped with a patterned member according to a preferred embodiment of the present invention;

FIG. 7 illustrates a patterned member according to a preferred embodiment of the present invention;

FIGS. 8A-8B are illustrations in detail of the patterned member depicted in FIG. 7;

FIGS. 9 and 10 illustrate an actuator for camera and a camera module in accordance with another embodiment of the present invention;

FIG. 11 illustrates the path of light reflected from the protrusions according to the present invention.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

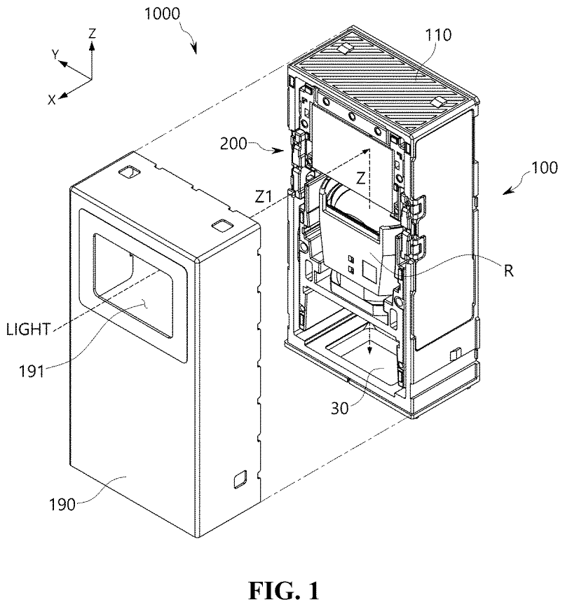

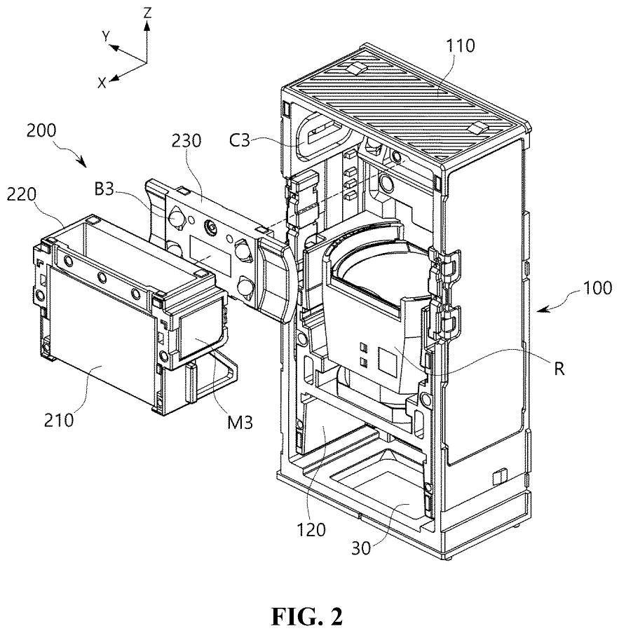

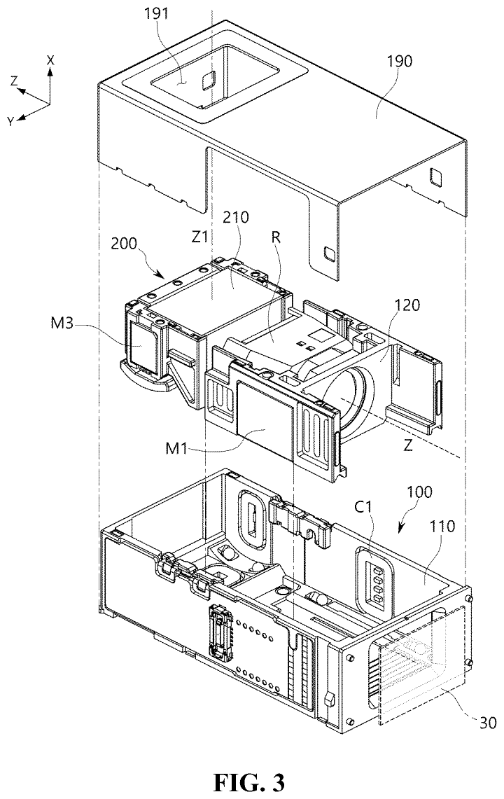

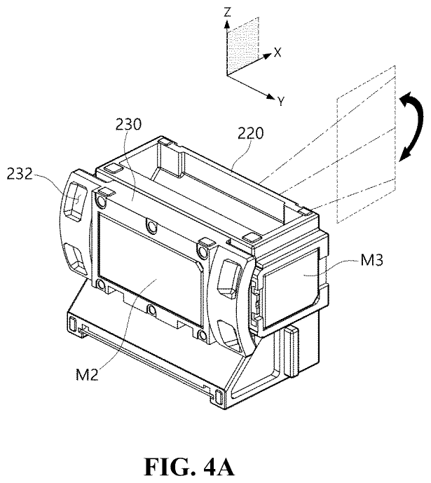

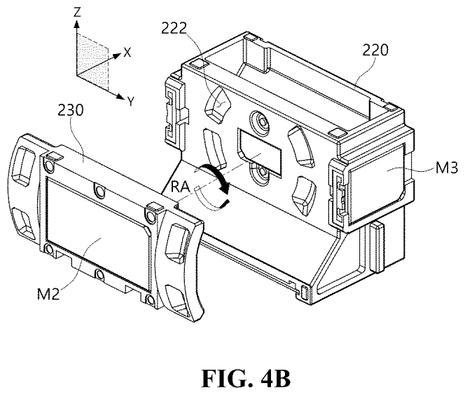

FIGS. 1 to 3 depict the overall configuration of an actuator for camera (hereinafter referred to simply as “actuator”) (100) and a camera module (1000) in accordance with a preferred embodiment of the present invention. FIGS. 4A-4B illustrates the configuration in detail of the reflectometer module (200) according to a preferred embodiment of the present invention.

The actuator (100) of the present invention can be embodied as part of a camera module (1000) along with such other parts as a reflectometer module (200) as illustrated in FIG. 1, or needless to say, as a single stand-alone device.

The actuator (100) of the present invention is for carrying out autofocusing or zooming by driving in a linear motion along the optical axis a single carrier or each of a plurality of carriers to which a lens module (lens assembly)(R) is attached.

The reflectometer module (200), which can be set up anterior (along the optical axis) to the actuator (100) of the present invention, reflects or refracts the path (Z1) of light from an object upon its entry through, e.g., an opening (191) formed on the case (190) serving inter alia as a shield can, towards an optical path (Z1) in the direction of the lens module (R). The light thus reflected or refracted towards the optical axis passes the lens module (R) and enters the image sensor (30) such as complementary metal oxide semiconductors (CMOS) and charge coupled devices (CCD).

The reflectometer module (200) for modifying the optical path may comprise a reflectometer (210) that may consist of one selected from a mirror, a prism or a combination of both. The reflectometer (210) can be constructed from a variety of material capable of modifying the path of the incoming light from the outside toward the optical axis, but for the purpose of high performance optical properties, glass is the preferred medium.

The camera module (1000) of the present invention comprising such elements as the reflectometer module (200) is configured to refract the path of light toward the lens. This allows the entire device to be set up lengthwise along the mobile terminal instead of across its width so as to help keep the mobile terminal small and slim.

In certain embodiments, the reflectometer (210) is configured to move in rotational motion by the action of driving means capable of generating magnetic field such as magnets and coils. Thus, as the reflectometer (210) moves or moves in rotational motion, the light from the object reflected (refracted) by the reflectometer (210) is led along the ±Y-axis and/or ±X-axis to enter the lens and image sensor (30), thereby enabling corrections to camera shake along the X-axis and/or Y-axis.

Specifically, the reflectometer module (200) can be configured to comprise a rotating carrier (220) equipped with a reflectometer (210) and a middle guide (230).

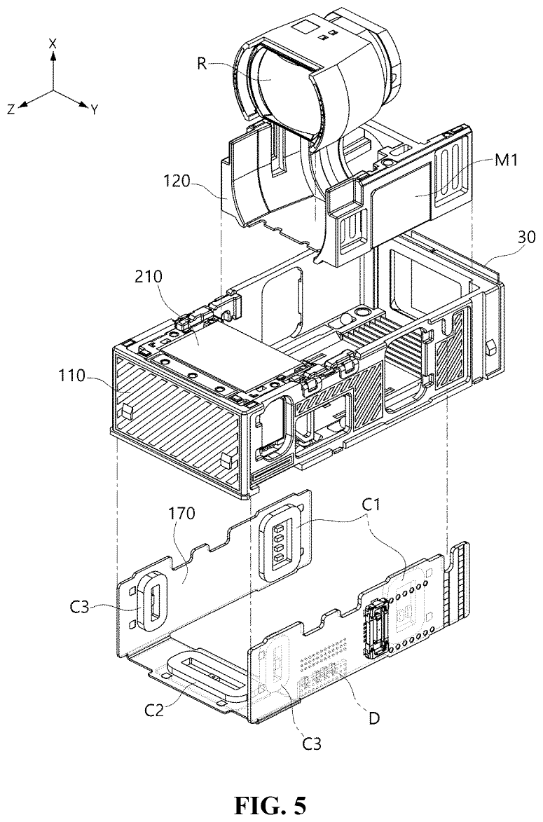

The rotating carrier (220) is configured to move in a rotational motion in reference to the middle guide (230) once electromagnetic force is generated between the third coil (C3, see FIG. 5) attached to the housing (110) side and the third magnet (M3) mounted on the rotating carrier (220). The drawings illustrate an embodiment in this regard in which the rotating carrier (220) moves in a rotational motion within the YZ-plane with the middle guide (230) as a fixed reference.

Thus, as the rotating carrier (220) moves in a rotational motion around the X-axis (RA, see FIGS. 4A-4B) within the YZ-plane, so does the reflectometer (210) accompanying it in the same physical movement in the same direction.

Thus, when the reflectometer (210), having a sloping surface from which the light from the object reflects, moves in a rotational motion within the YZ-plane as described, the incoming light towards the image sensor (30) shifts its path in the direction of the Y-axis, thereby making corrections to the Y-axis component of the camera shake.

In certain embodiments, at least on one of those surfaces of the middle guide (230) and the rotating carrier (220) that faces the other, can be formed a guiding rail (222) that accommodates or guides the third ball (B3).

Meanwhile the middle guide (230) moves with the rotating carrier (220) attached to it in a rotational motion within the XZ-plane when the second coil (C2, see FIG. 5) provides driving force to the second magnet (M2) equipped to the lower part (based on the X-axis) of the middle guide (230).

Thus, as the middle guide (230) moves in a rotational motion within the XZ-plane, so does the reflectometer (210) and the incoming light towards the image sensor (30) shifts its path in the direction of the X-axis, thereby making corrections to the X-axis component of the camera shake.

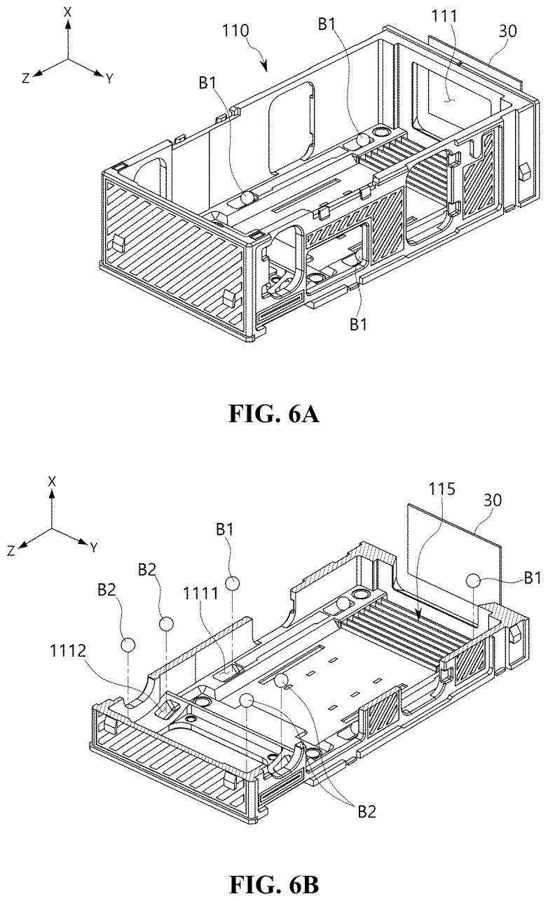

As illustrated in the drawings, a guide rail (232) with a rounded shape that accommodates part of a second ball (B2, see FIGS. 6A-6B) can be formed on the rear face of the middle guide (230) to guide the middle guide (230) move in a rotational motion (within the XZ-plane).

The light from the object thus reflected by the reflectometer module (200) enters into the lens module (R) equipped within the actuator (100), and functions such as zooming and autofocusing are carried out by the actuator (100) of the present invention making adjustments to the positions along the optical axis of the lens module (R).

The image sensor (30) can be configured inside the actuator (100) of the present invention, or more specifically inside the housing (110) since the image sensor (30) can be designed to interface with the mainboard of the application (e.g., smartphones) in which the actuator (100) of the present invention is installed. Needless to say, the image sensor (30) can alternatively be placed at a position outside the actuator (100) and corresponding to the aperture (111) formed on the housing (110) as illustrated in the drawings.

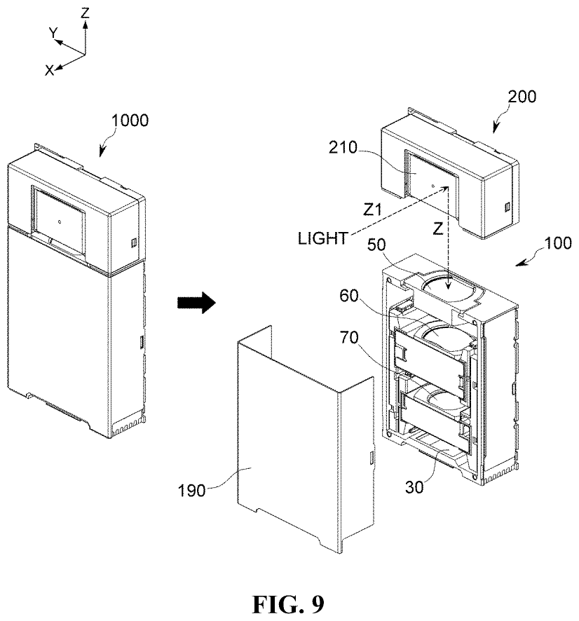

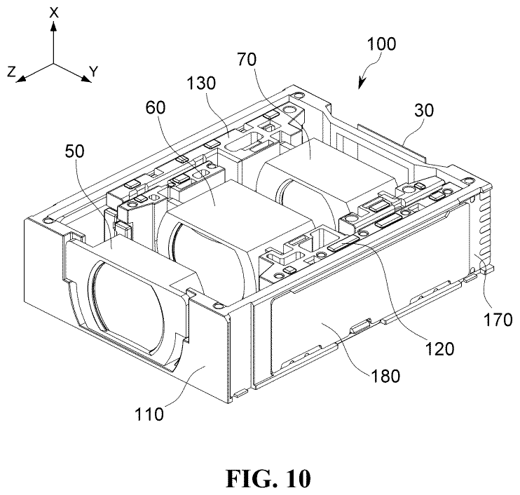

Furthermore, there can be multiple carriers (120, 130) that move along the optical axis with each of them mounting a lens (lens assembly)(60, 70) as illustrated in FIGS. 9 and 10. In such embodiment, a fixed lens (50) can be set up anterior to the actuator (100) as illustrated in FIG. 10 to enhance optical performances such as actuator (100) zoom ratio.

The reflectometer module (200) equipped with a reflectometer (210) can be implemented as a stand-alone module as illustrated in FIGS. 9 and 10. Moreover, in certain embodiments, a yoke plate (100) can be attached to the actuator (100) of the present invention so that the magnetic force is not dissipated and focused upon the magnet.

It should be obvious to a skilled practitioner that the axes depicted in the drawings herein, the references to these axes, and the terms herein defining directions in reference to the particular axis in question such as upper, lower, anterior, posterior and perpendicular are used simply to provide a relative standard in describing the embodiments of the present invention and are not intended to define in absolute terms a particular direction or position. It should be readily apparent that such direction or position may vary in relation to the factors such as the position of the object in question, the position of the viewer and the direction of the view.

For the purpose of describing the embodiments of the present invention, hereinafter, the optical axis (Z-axis), i.e., the axis corresponding to the path of the incoming light toward the lens module (R) etc., will be the reference point for defining anterior and posterior as described above. Similarly, the Y-axis will be the reference point for defining left and right, whereas the X-axis will be the reference point for the upper, lower or perpendicular direction.

FIG. 5 illustrates the configuration in detail of an actuator (100) of the present invention. FIGS. 6A-6B illustrates a housing (110) equipped with a patterned member (115) according to a preferred embodiment of the present invention.

As depicted in FIG. 5, the actuator (100) of the present invention comprises a housing (110) that amounts to the basic frame of the actuator (100) and accommodates the inner parts as well as a lens module (R) that emits light towards the image sensor (30). In certain embodiments, the actuator (100) can comprise a carrier (120) mounting the lens module (R).

The carrier (120) mounting the lens module (R) amounts to a moving body in linear motion along the optical axis (Z-axis), while correspondingly the housing (110) amounts to a fixed body.

The carrier (120) is equipped with a first magnet (M1) and in the housing (110) is equipped a first coil (C1) that faces and imparts driving force to the first magnet (M1).

Once power of appropriate magnitude and direction is applied by an operating driver (D) to the first coil (C1), electromagnetic force is generated between the first coil (C1) and the first magnet (M1), and this force generated moves the carrier (120) back and forth along the optical axis.

Although the accompanying figures illustrate one single carrier (120) mounting a lens module (R), this is merely one of the possible examples. Needless to say, multiple lenses (60, 70) and carriers (120, 130) can be comprised depending on the particular embodiment as illustrated in FIGS. 9 and 10.

Accordingly, as the each carrier (120) moves linearly along the optical axis (along the Z-axis), so does the lens module (R) mounted on the carrier (120) along the optical axis, thereby implementing zooming or auto-focusing.

A first ball (B1) is preferably placed between the carrier (120) and the housing (110) so that the carrier (120) may move in smooth linear motion with the least friction.

To implement an effective guiding towards linearity in path, it is preferred that the guiding rail (1111) is configured to accommodate part of the first ball (B1) where the guiding rail (1111) is extended along the optical axis and formed on one or more of the carrier (120) and the housing (110). The guiding rail (1112) illustrated in FIGS. 6A-6B faces the guiding rail (232) of the middle guide (230) described in reference to FIGS. 4A-4B. The guiding rail (1112) guides the rotation (XZ-plane) of the reflectometer module (200) mediated by the second ball (B2) and the like.

As illustrated in the accompanying drawings, a patterned member (115) is formed on the internal surface of the housing (110) in the present invention. The patterned member (115) serves to suppress flare, that is, block unnecessary light coming into the image sensor (30) by dispersing or scattering the component of light that passed the lens module (R) and got reflected off the internal surfaces of the housing (110).

The patterned member (115) of the present invention thus is an element whose function is to abate and attenuate the component of light entering the image sensor (30) the light having passed the lens module (R) and thereafter having been reflected off the housing (110). It is therefore preferred that, as illustrated, the location of the patterned member (115) lies posterior (along the Z-axis) to the lens module (R) and on the path through which the light travels toward the image sensor (30) after passing the lens module (R), i.e., on one of the internal surfaces of the housing (110) located between the lens module (R) and the image sensor (30).

Although the patterned member (115) of the present invention is preferably disposed on the bottom face of the housing (110) so as to place it in correspondence with the sloping surface of the reflectometer (210), the patterned member (115) can alternatively be disposed on the one or more internal surfaces of the housing (110), and depending on the embodiment, disposed on the internal surface (upper face) of the case (190) as well.

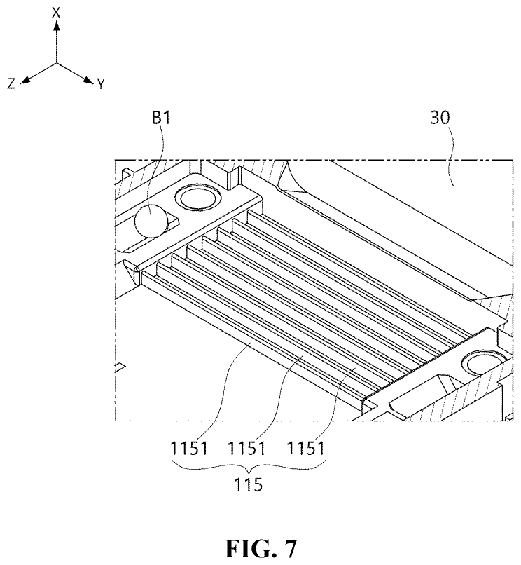

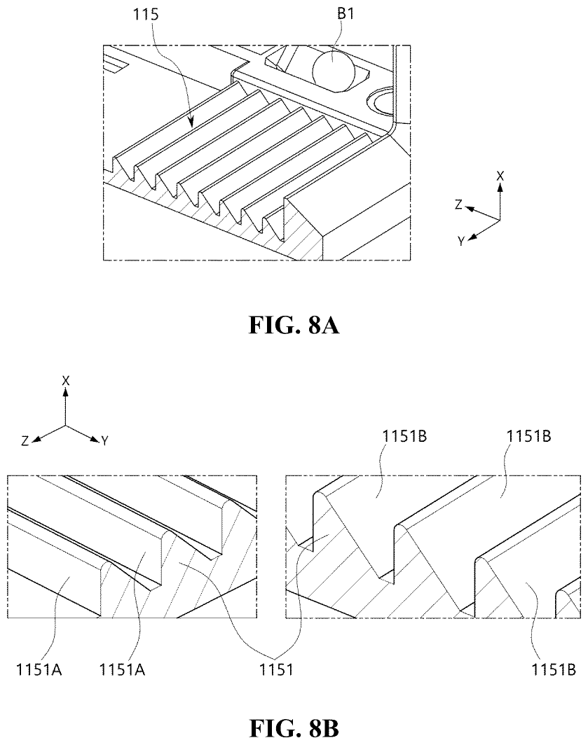

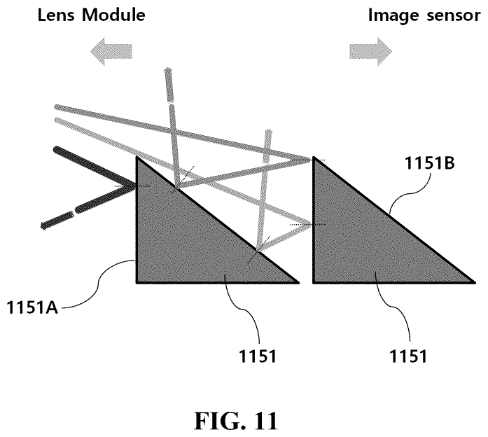

FIG. 7 illustrates a patterned member (115) according to a preferred embodiment of the present invention while FIGS. 8A-8B illustrates in detail of the patterned member (115) depicted in FIG. 7. FIG. 11 is a drawing describing the path of light reflected from the protrusions (1151) according to the present invention.

As illustrated in the drawings, the patterned member (115) is preferably configured so that protrusions (1151) are arranged anterior and posterior (along the Z-axis) in repetition, with each protrusion (1151) extending lengthwise along a direction (Y-axis) perpendicular to the optical axis (Z-axis).

In consideration of the orientation and angle of the incoming light entering the image sensor (30) after passing the lens module (R) and reflecting off the internal surface of the housing (110), each protrusion (1151) preferably has a triangular cross-section (in the XZ-plane) as illustrated.

More preferably, the protrusion (1151) comprises a vertical surface (1151A) standing perpendicular to (and rising in the direction of the X-axis from) the internal surface of the housing (110) and a sloping surface (1151B) whose face points towards the image sensor (30).

That is, the protrusions (1151) in general jut forward towards the inside from an internal surface of the housing (110) with each protrusion's anterior side (in reference to the Z-axis) standing perpendicular to that internal surface of the housing (110) while each protrusion's posterior side reclining to form the sloping surface (1151B) that faces towards the image sensor (30).

Configuring the protrusions (1151) as described provides effective means for guiding the light directly incident on the vertical surface (1151A) to be reflected off in a direction opposite to the incident one as illustrated in FIG. 11.

In addition, the posterior sides of the protrusions (1151) are arranged into a repetitive array of sloping surfaces (1151B) in which two consecutive protrusions (1151) can form a pair of a ridge and a valley. Such configuration enables broadening the area in the internal surface of the housing (110) that faces the light emerging from the lens module (R), and this broadening contributes to further attenuation in power of the light.

Moreover, such configuration allows the incoming light falling between two consecutive ridges to be refracted away from the image sensor (30) by means of reflection off the vertical surface (1151A) of the posterior protrusion (1151) in the consecutive pair.

Furthermore, the component of light directly entering the image sensor (30) can be minimized since part of the light refracted by the vertical surface (1151A) of the posterior protrusion (1151) is steered toward a follow-up refraction by the sloping surface (1151B) of the anterior protrusion (1151) of the consecutive pair to result in an angle of reflection larger than the first angle incidence.

For the purpose of effectively steering the refracted light from travelling back to the image sensor (30), it is most preferred that the angle between the sloping surface (1151B) and the internal surface of the housing (110) is 45 degrees or less.

In certain embodiments, the patterned member (115) is preferably subject to surface treatments such as laser etching (corrosion), arc discharge and chemical treatments to roughen its exposed surface. Such surface treated patterned member (115) is capable of attenuating the reflective behavior of light on the whole due to the fine (a few micrometers) cracks formed upon its surface.

Since the patterned member (115) of the present invention relies as described above on the structure or shape formed on the housing (110) itself for attenuating light reflection but not on the use of foreign material such as fiber, film or paint, its production can be readily integrated into manufacturing process for the housing (110) by molding (injection, press fitting, etc.), yielding a patterned member (115) made integral to the housing (110).

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

Reference Signs

| | |
|---|---|
| 1000: camera module | |
| 100: actuator | 110: housing |
| 111: aperture | 115: patterned member |
| 1151: protrusion | 1151A: vertical surface |
| 1151B: sloping surface | 120 (130): carrier |
| 170: circuit board | 180: yoke plate |
| 190: case | 191: opening |
| 1111, 1112, 222, 232: guiding rails | |
| 30: image sensor | 50: fixed lens |
| 60, 70, R: lenses | |
| B1: first ball | B2: second ball |
| B3: third ball | C1: first coil |
| C2: second coil | C3: third coil |
| M1: first magnet | M2: second magnet |
| M3: third magnet | D: operating driver |
| 200: reflectometer module | 210: reflectometer |
| 220: rotating carrier | 230: middle guide |

What is claimed is:

1. An actuator for camera comprising:
a lens module emitting light towards an image sensor;
a housing enclosing the lens module; and
a patterned member disposed on the internal surface of the housing, said internal surface being the one between the lens module and the image sensor;
wherein the patterned member comprises protrusions arranged in repetition anterior and posterior along an optical axis,
wherein each protrusion
extends lengthwise along a direction perpendicular to the optical axis and has a triangular cross section, and
comprises a vertical surface perpendicular to the internal surface of the housing; and
a sloping surface the face thereof pointing towards the image sensor.

2. The actuator according to claim 1 further comprising a reflectometer module disposed anterior to the lens module and reflecting the light from the object towards the lens module.

3. The actuator according to claim 1, wherein the exposed face of the patterned member has been subject to a roughening surface treatment.

4. The actuator according to claim 1, wherein the patterned member is formed integral to the housing.
